(19) United States
(12) Patent Application Publication
(10) Pub. No.: US 2023/0335308 A1
(43) Pub. Date: Oct. 19, 2023

(54) ANISOTROPIC CONDUCTIVE SHEET, ANISOTROPIC CONDUCTIVE SHEET MANUFACTURING METHOD, ELECTRICAL INSPECTION DEVICE, AND ELECTRICAL INSPECTION METHOD

(71) Applicant: MITSUI CHEMICALS, INC., Minato-ku, Tokyo (JP)

(72) Inventors: Katsunori Nishiura, Chiba-shi (JP); Daisuke Yamada, Hidaka-shi (JP)

(21) Appl. No.: 18/073,609

(22) PCT Filed: Jul. 8, 2021
(86) PCT No.: PCT/JP2021/025714

§ 371 Date: Dec. 2, 2022

(30) Foreign Application Priority Data
Jul. 10, 2020 (JP) 2020-119278

(51) Int. Cl. H01B 3/00; H01B 3/46; H01B 1/02; H01B 5/16; H01B 17/66

(52) U.S. Cl. CPC H01B 3/004; H01B 3/46; H01B 1/026; H01B 5/16; H01B 17/66

(57) ABSTRACT

This anisotropic conductive sheet has an insulation layer, a plurality of conduction paths, and a plurality of adhesion layers disposed therebetween. The adhesion layers each contain a silane coupling agent composition containing a silane coupling agent having a vinyl group and a hydrolyzable group, or a polycondensate of said composition. In the anisotropic conductive sheet: a) the insulation layer contains an addition crosslinked product of a silicone rubber composition containing an organopolysiloxane having a SiH group, and the vinyl groups of the adhesion layers is bound to the SiH group of the insulation layer through an addition reaction; or b) the insulation layer contains an organic peroxide crosslinked product of a silicone rubber composition containing an organopolysiloxane having a SiCH₃ group, the vinyl groups of the adhesion layers is bound to the SiCH₃ group of the insulation layer through a radical addition reaction.

### TECHNICAL FIELD

The present invention relates to an anisotropic conductive sheet, a method for producing the anisotropic conductive sheet, an electrical testing apparatus, and an electrical testing method.

### BACKGROUND ART

Semiconductor devices such as printed circuit boards to be mounted in electronic products are usually subjected to electrical testing. Typically, electrical testing is performed as follows: electrically contacting a substrate (with electrodes thereon) of an electrical testing apparatus with terminals of an object to be inspected (herein also referred to as “inspection object”) such as a semiconductor device; and reading the current obtained when a predetermined voltage is applied between the terminals of the inspection object. Then, for the purpose of reliably performing the electrical contact between the electrodes of the substrate of the electrical testing apparatus and the terminals of the inspection object, an anisotropic conductive sheet is disposed between the substrate of the electrical testing apparatus and the inspection object.

An anisotropic conductive sheet has conductivity in the thickness direction thereof and insulating properties in the surface direction thereof, and is used as a probe (contact) in electrical testing. Such an anisotropic conductive sheet is used with an indentation load applied thereon in order to reliably perform electrical connection between the substrate of the electrical testing apparatus and the inspection object. Therefore, the anisotropic conductive sheet is required to be readily and elastically deformed in the thickness direction thereof.

An anisotropic conductive sheet known to satisfy such a requirement includes an insulation layer that includes silicone rubber as its component, and a plurality of metal wires disposed so as to pass through the insulation layer in the thickness direction of the insulation layer (for example, Patent Literature (hereinafter, referred to as PTL) 1). In addition, known is an electrical connector that includes an elastic body (such as a silicone rubber sheet) including a plurality of through holes passing therethrough in the thickness direction of the elastic body, and a plurality of hollow conductive members joined to the inner wall surfaces of the through holes (for example, PTL 2).

### CITATION LIST

### Patent Literature

PTL 1
Japanese Patent Application Laid-Open No. 2016-213186
PTL 2
WO2018/212277

### SUMMARY OF INVENTION

### Technical Problem

In recent years, there is a demand for a further reduction in the indentation load during the electrical testing, and studies has been conducted for further reduction in the elastic modulus of materials constituting conductive paths, such as metal wires and conductive parts. However, the reduction of the elastic modulus of the material constituting a conductive path causes a problem such that poor conduction is more likely to be caused due to the conductive path peeling off from the insulation layer by the repetition of pressurization with an indentation load and depressurization. PTLs 1 and 2 also have similar problems.

The present invention has been made in view of the above problems. An object of the present invention is to provide an anisotropic conductive sheet that can maintain satisfactory adhesion and suffers little peeling of a conductive path even after repeated elastic deformation, a method for producing the anisotropic conductive sheet, an electrical testing apparatus, and an electrical testing method.

### Solution to Problem

The above-described object can be achieved by the following configurations.

A first anisotropic conductive sheet of the present invention includes: an insulation layer including a first surface located on one side in a thickness direction of the insulation layer, and a second surface located on another side in the thickness direction; a plurality of conductive paths disposed in the insulation layer so as to each extend in the thickness direction, each of the plurality of conductive paths being exposed to an outside of the first surface and an outside of the second surface; and a plurality of adhesive layers, at least part of each of the plurality of adhesive layers being disposed between a corresponding one of the plurality of conductive paths and the insulation layer, in which
each of the plurality of adhesive layers includes a silane coupling agent composition and/or a polycondensate thereof, the silane coupling agent composition containing a silane coupling agent having at least one vinyl group and at least one hydrolyzable group, and
the anisotropic conductive sheet satisfies any one of a) and b) below:
a) the insulation layer contains an addition cross-linked product of a silicone rubber composition, the silicone rubber composition containing an organopolysiloxane having at least one SiH group, an organopolysiloxane having at least one vinyl group, and an addition reaction catalyst, and
at least part of the at least one vinyl group in each of the plurality of adhesive layers is bonded to at least part of the at least one SiH group in the insulation layer by an addition reaction, and
b) the insulation layer contains a cross-linked product of a silicone rubber composition, the silicone rubber composition containing an organopolysiloxane having at least one SiCH₃ group, and an organic peroxide curing agent, and
at least part of the at least one vinyl group in each of the plurality of adhesive layers is bonded to at least part of the at least one SiCH₃ group in the insulation layer by a radical addition reaction.

A method for producing the first anisotropic conductive sheet of the present invention includes: 1) preparing a plurality of units each including an insulation layer, a plurality of conductive lines disposed on or above a surface of the insulation layer, and an adhesive layer covering at least part of peripheries of the plurality of conductive lines, the adhesive layer containing a silane coupling agent composition and/or a polycondensate thereof, 2) stacking and integrating the plurality of units to obtain a laminate; and 3) cutting the laminate in a cutting direction along a stacking direction of the laminate to obtain an anisotropic conductive sheet, the cutting direction intersecting an extending direction of at least one of the plurality of conductive lines, in which
the silane coupling agent composition contains a silane coupling agent having at least one vinyl group and at least one hydrolyzable group, and
the method satisfies any one of a) and b) below:
a) the insulation layer contains an addition cross-linked product of a silicone rubber composition, the silicone rubber composition containing an organopolysiloxane having at least one SiH group, an organopolysiloxane having at least one vinyl group, and an addition reaction catalyst, and
in the preparing, at least part of the at least one vinyl group in the adhesive layer is subjected to an addition reaction with at least part of the at least one SiH group in the insulation layer,
b) the insulation layer contains a cross-linked product of a silicone rubber composition, the silicone rubber composition containing an organopolysiloxane having at least one SiCH₃ group, and an organic peroxide curing agent, and in the preparing, at least part of the at least one vinyl group in the adhesive layer is
subjected to a radical addition reaction with at least part of the at least one SiCH₃ group in the insulation layer.

A second anisotropic conductive sheet of the present invention includes: an insulation layer including a first surface located on one side in a thickness direction of the insulation layer, and a second surface located on another side in the thickness direction; a plurality of conductive paths disposed in the insulation layer so as to each extend in the thickness direction, each of the plurality of conductive paths being exposed to an outside of the first surface and an outside of the second surface; and a plurality of adhesive layers, at least part of each of the plurality of adhesive layers being disposed between a corresponding one of the plurality of conductive paths and the insulation layer, in which the insulation layer contains an addition cross-linked product of a silicone rubber composition having at least one vinyl group; each of the plurality of adhesive layers includes a silane coupling agent composition and/or a polycondensate thereof, the silane coupling agent composition containing a silane coupling agent having at least one SiH group and at least one hydrolyzable group; and at least part of the at least one SiH group in each of the plurality of adhesive layers is bonded to at least part of the at least one vinyl group in the insulation layer by the addition reaction.

A method for producing the second anisotropic conductive sheet of the present invention includes: 1) preparing a plurality of units each including an insulation layer containing an addition cross-linked product of a silicone rubber composition having at least one vinyl group, a plurality of conductive lines disposed on or above a surface of the insulation layer, and an adhesive layer covering at least part of peripheries of the plurality of conductive lines, the adhesive layer containing a silane coupling agent composition and/or a polycondensate thereof, 2) stacking and integrating the plurality of units to obtain a laminate; and 3) cutting the laminate in a cutting direction along a stacking direction of the laminate to obtain an anisotropic conductive sheet, the cutting direction intersecting an extending direction of at least one of the plurality of conductive lines, in which
in the preparing, the silane coupling agent composition contains a silane coupling agent having at least one SiH group and at least one hydrolyzable group; and at least part of the at least one SiH group is subjected to the addition reaction with at least part of the at least one vinyl group in the insulation layer.

An electrical testing apparatus of the present invention includes: an inspection board including a plurality of electrodes; and the anisotropic conductive sheet of the present invention disposed on or above the surface, where the plurality of electrodes are disposed, of the inspection board.

An electrical testing method of the present invention includes: stacking an inspection board including a plurality of electrodes and an inspection object including a terminal via the anisotropic conductive sheet of the present invention, and electrically connecting the plurality of electrodes of the inspection board with the terminal of the inspection object via the anisotropic conductive sheet.

### Advantageous Effects of Invention

The present invention is capable of providing an anisotropic conductive sheet that can maintain satisfactory adhesion and suffers little peeling of a conductive path even after repeated elastic deformation, a method for producing the anisotropic conductive sheet, an electrical testing apparatus, and an electrical testing method.

### BRIEF DESCRIPTION OF DRAWINGS

FIG. 1A is a partially enlarged plan view illustrating an anisotropic conductive sheet according to the present embodiment, and FIG. 1B is an enlarged cross-sectional view of the anisotropic conductive sheet in FIG. 1A taken along line 1B-1B;

FIG. 2 is an enlarged view of FIG. 1B;

FIGS. 3A to 3H are schematic cross-sectional views illustrating some of the steps of a method for producing the anisotropic conductive sheet according to the present embodiment;

FIGS. 4A to 4C schematically illustrate the rest of the steps of the method for producing the anisotropic conductive sheet according to the present embodiment;

FIGS. 5A and 5B schematically illustrate the adhesion mechanism by a silane coupling agent composition;

FIG. 6 is a cross-sectional view illustrating an electrical testing apparatus according to the present embodiment; and

FIGS. 7A to 7G are schematic cross-sectional views illustrating some of the steps of a method for producing an anisotropic conductive sheet according to a variation.

### DESCRIPTION OF EMBODIMENTS

1. Anisotropic Conductive Sheet

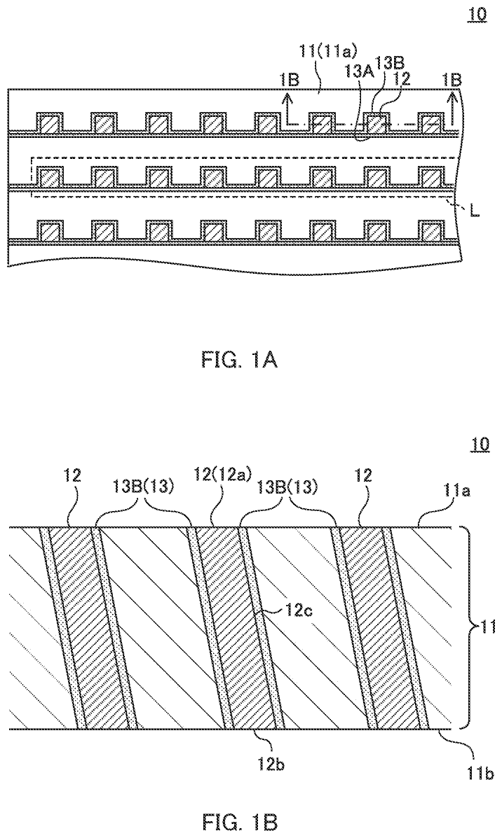

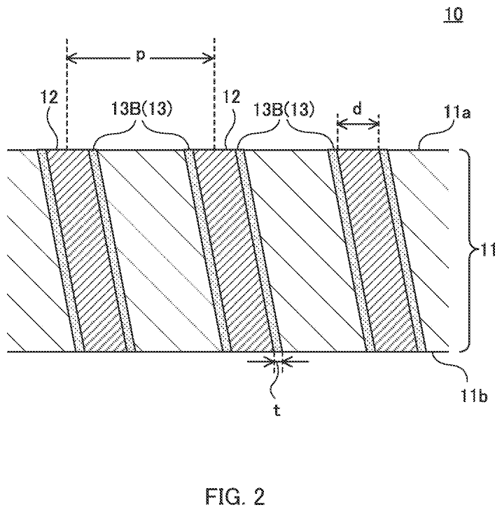

FIG. 1A is a partially enlarged plan view illustrating anisotropic conductive sheet 10 (first anisotropic conductive sheet) according to the present embodiment, and FIG. 1B is an enlarged cross-sectional view of anisotropic conductive sheet 10 of FIG. 1A taken along line 1B-1B. FIG. 2 is an enlarged view of FIG. 1B. All the drawings described below are schematic diagrams, and the scale and the like are different from the actual dimensions.

Anisotropic conductive sheet 10 includes insulation layer 11, plurality of conductive paths 12 disposed inside insulation layer 11, and plurality of adhesive layers 13. Plurality of conductive paths 12 are disposed in such a way that each conductive path extends in the thickness direction of the insulation layer and at least part of each adhesive layer 13 is disposed between each conductive path 12 and insulation layer 11.

1-1. Insulation Layer 11

Insulation layer 11 includes first surface 11a located on one side in the thickness direction of the insulation layer and second surface 11b located on the other side in the thickness direction (see FIGS. 1A and 1B). Insulation layer 11 provides insulation between plurality of conductive paths 12. One insulating layer 11 may be separated by at least one adhesive layer 13, as illustrated in FIG. 1A. In the present embodiment, first surface 11a of insulation layer 11 forms one surface of anisotropic conductive sheet 10, and second surface 11b of insulation layer 11 forms the other surface of anisotropic conductive sheet 10. In addition, an inspection object is preferably disposed on or above first surface 11a of insulation layer 11.

Insulation layer 11 contains either a) a cross-linking product of a silicone rubber composition obtained by addition cross-linking (herein simply referred to as “addition cross-linked product” of a silicone rubber composition) or b) a cross-linking product of a silicone rubber composition obtained by an organic peroxide cross-linking. In the present embodiment, insulation layer 11 contains a) an addition cross-linked product of a silicone rubber composition.

The addition cross-linked product a) of a silicone rubber composition is obtained by addition cross-linking a silicone rubber composition that contains an organopolysiloxane having vinyl groups (herein also referred to as “vinyl group-containing organopolysiloxane”), an organopolysiloxane (organohydrogenpolysiloxane) having SiH groups (herein also referred to as “SiH group-containing organopolysiloxane”), and an addition reaction catalyst. The addition cross-linked product has a SiH group (to be bonded with a vinyl group of a silane coupling agent).

A vinyl group-containing organopolysiloxane is the main ingredient (base polymer) of the silicone rubber composition, and has at least two vinyl groups each bonded to a silicon atom or groups each containing such a vinyl group (for example, allyl group) per molecule. Examples of organic groups other than a vinyl group or a group containing a vinyl group include methyl group, ethyl group, and phenyl group, preferably methyl group.

The vinyl groups or allyl groups may be in the inside of the main chain of a molecule, at the terminal(s) of the molecule, or in the inside and at the terminal(s), but are preferably at the terminal(s) of the molecule. An exemplary vinyl group-containing organopolysiloxane is a dimethylpolysiloxane having vinyl groups at both ends thereof.

An SiH group-containing organopolysiloxane is an organohydrogenpolysiloxane having at least 2, preferably 3 or more hydrogen atoms, each bonded to a silicon atom (SiH groups) per molecule. The SiH group may be in the inside of the main chain of a molecule, at the terminal(s) of the molecule, or in the inside and at the terminal(s). The SiH group-containing organopolysiloxane functions as a curing agent (cross-linker), and causes the curing by cross-linking of the SiH group therein with the vinyl group in the vinyl group-containing organopolysiloxane through a hydrosilylation addition reaction.

Examples of the SiH group-containing organopolysiloxane include methylhydrogenpolysiloxane and methylhydrogenpolysiloxane in which some or all of the methyl groups are substituted with another alkyl group, phenyl group, or the like.

The content of the SiH group-containing organopolysiloxane is set in such a way that unreacted SiH groups remain in the resulting addition cross-linked product.

An addition reaction catalyst may be added to promote the hydrosilylation reaction between the vinyl group-containing organopolysiloxane and the SiH group-containing organopolysiloxane. As the addition reaction catalyst, for example, known metals, metal compounds, and metal complexes having catalytic activity for the hydrosilylation reaction can be used. In particular, platinum, platinum compounds, and complexes thereof are preferably used.

Insulation layer 11 may be formed porous from the viewpoint of facilitating adjustment of the storage elastic modulus of the insulation layer 11 to fall in an appropriate range.

The hardness of the addition cross-linked product of the silicone rubber composition measured with a durometer (type A) according to JIS K6253 is not limited as long as the cross-linked product can be elastically deformed by an indentation load during electrical testing. For example, the hardness is preferably 30 to 90 degrees.

1-2. Conductive Path 12

Conductive path 12 is disposed inside insulation layer 11 so as to extend in the thickness direction of the insulation layer and to be exposed on first surface 11a and second surface 11b (see FIG. 1B).

Conductive path 12 extending in the thickness direction of insulation layer 11 may specifically refer to the following: the axial direction of conductive path 12 is substantially parallel to the thickness direction of insulation layer 11 (specifically, the smaller one of the angles between the thickness direction of insulation layer 11 and the axial direction of conductive path 12 is 100 or less); or the axial direction is inclined with respect to the thickness direction at an angle within a predetermined range (the smaller one of the angles between the thickness direction of insulation layer 11 and the axial direction of conductive path 12 is more than 10° and 450 or less). In particular, from the viewpoint of facilitating elastic deformation and electrical connection when an indentation load is applied, the axial direction of conductive path 12 is preferably inclined with respect to the thickness direction of insulation layer 11 (see FIG. 1B). The axial direction refers to the direction connecting end 12a on the first surface 11a side with end 12b on the second surface 11b side in conductive path 12. In other words, conductive path 12 is disposed in such a way that end 12a is exposed on the first surface 11a side and end 12b is exposed on the second surface 11b side (see FIG. 1B).

The shape of conductive path 12 is not particularly limited, and may be cylindrical or prismatic. In the present embodiment, conductive path 12 has a shape of a quadrangular prism (see FIGS. 1A and 1B).

Equivalent circle diameter (i.e., diameter of an equivalent circle) d of end 12a of conductive path 12 on the first surface 11a side may be any value as long as center-to-center distance p of ends 12a of plurality of conductive paths 12 on the first side 11a side falls within a range described below, and satisfactory conduction of the terminals of an inspection object with conductive paths 12 can be obtained. Equivalent circle diameter d is preferably 2 to 30 μm, for example. Equivalent circle diameter d of end 12a of conductive path 12 on the first surface 11a side refers to the equivalent circle diameter of end 12a of conductive path 12 as viewed along the thickness direction of insulation layer 11 from the first surface 11a side.

The equivalent circle diameter of end 12a of conductive path 12 on the first surface 11a side may be the same as (see FIG. 1B) or different from the equivalent circle diameter of end 12b of conductive path 12 on the second surface 11b side.

Center-to-center distance (pitch) p of plurality of conductive paths 12 on the first surface 11a side is not limited, and may be appropriately set in accordance with the pitch of the terminals of an inspection object. As an inspection object, a high bandwidth memory (HBM) has the pitch between the terminals of 55 μm, and a package on package (PoP) has the pitch between the terminals of 400 to 650 μm. From the viewpoint of matching the anisotropic conductive sheet with these inspection objects, center-to-center distance p of ends 12a of plurality of conductive paths 12 on the first surface 11a side may be, for example, 5 to 650 μm. In particular, from the view point of eliminating the need for the alignment of the terminals of the inspection object (from the view point of achieving alignment free), center-to-center distance p of plurality of conductive paths 12 on the first surface 11a side is preferably 5 to 55 μm. Center-to-center distance p of plurality of conductive paths 12 refers to the minimum value among the center-to-center distances of plurality of conductive paths 12.

Center-to-center distance p of plurality of conductive paths 12 on the first surface 11a side may be the same as (see FIG. 1B) or may be different from the center-to-center distance of plurality of conductive paths 12 on the second surface 11b side.

Plurality of conductive paths 12 may be disposed randomly or in a matrix. In the present embodiment, plurality of conductive paths 12 are disposed in a matrix. Specifically, the matrix of conductive paths 12 are formed from plurality of lines L, and each line L includes plurality of conductive paths 12 arranged in a row (see FIG. 1A).

Any material having conductivity may be used as the material for conductive path 12. The volume resistivity of the material for conductive path 12 is not limited as long as satisfactory conductivity can be obtained. For example, the volume resistivity is preferably 1.0×10⁻⁴ Ω·m or less, more preferably 1.0×10⁻⁶ to 1.0×10⁻⁹ Ω·m. The volume resistivity can be measured by the method described in ASTM D 991.

The elastic modulus of the material for conductive path 12 at 25° C. is not limited, but is preferably 50 to 100 GPa from the viewpoint of reducing the indentation load during electrical testing. Elastic modulus can be measured, for example, by a resonance method (in accordance with JIS Z2280).

Any material whose volume resistivity satisfies the above range may be used as the material for conductive path 12, and may be a metal material, selected from, for example, copper, gold, platinum, silver, nickel, tin, iron, and alloys thereof. In particular, at least one member selected from the group consisting of gold, silver, copper and alloys thereof is preferred, and copper and alloys thereof are more preferred, from the viewpoint of facilitating the reduction of the indentation load during electrical testing, and due to their satisfactory conductivity and flexibility.

Side surface 12c of conductive path 12 may be a smooth surface or a rough surface. From the viewpoint of reducing the possibility of impairing the high-frequency characteristics of anisotropic conductive sheet 10, the surface is preferably a smooth surface. Specifically, the surface preferably has a surface area ratio below a certain value (for example, the surface area ratio of 1 to 1.5). The surface area ratio is represented by the following equation: surface area ratio=surface area/area.

The surface area is a three-dimensional area of a measurement region with the depth (unevenness) thereof taken into account. The area is the two-dimensional area of the region visible when the measurement region is viewed from the normal direction thereof. The closer the surface area ratio is to 1, the less uneven the surface is, that is, the higher the surface area ratio is, the more uneven the surface is. The surface area and the area can be measured with a laser microscope. The measurement region may be 250 μm long by 250 μm wide. The measurement may be performed three times and the average value can be used as the surface area or the area.

1-3. Adhesive Layer

Adhesive layer 13 is disposed at least partially between plurality of conductive paths 12 and insulation layer 11 (see FIG. 1B). Adhesive layer 13 increases the adhesiveness between conductive path 12 and insulation layer 11, thereby reducing the possibility of separation at the interface between the conductive path 12 and the insulation layer 11. That is, adhesive layer 13 can also function as a joining layer or a primer layer for increasing the adhesiveness between conductive path 12 and insulation layer 11.

Adhesive layer 13 may be disposed on a part of side surface 12c of conductive path 12, or may be disposed on the entire side surface 12c. In the present embodiment, adhesive layer 13 is disposed on the entire side surface 12c of conductive path 12 (so as to surround side surface 12c) (see FIG. 1A).

Adhesive layer 13 may be composed of one layer, or may be composed of a plurality of layers.

In the present embodiment, adhesive layer 13 is disposed so as to surround side surface 12c of conductive path 12 and is composed of a plurality of layers. Specifically, adhesive layer 13 includes first adhesive layer 13A and second adhesive layer 13B.

First adhesive layer 13A is continuously disposed along line L of plurality of conductive paths 12 in such a way that the first adhesive layer 13A is in contact with side surfaces 12c on one side (undersides of side surfaces 12c in FIG. 1A) of respective conductive paths 12 included in line L. First adhesive layer 13A may be planar (plate-shaped) (see FIG. 1A) or curved.

Second adhesive layer 13B is continuously disposed on and/or above first adhesive layer 13A, and along line L of plurality of conductive paths 12 in such a way that the second adhesive layer 13B is in contact with side surfaces 12c on the other side (top sides of side surfaces 12c in FIG. 1A) of respective conductive paths 12 included in line L.

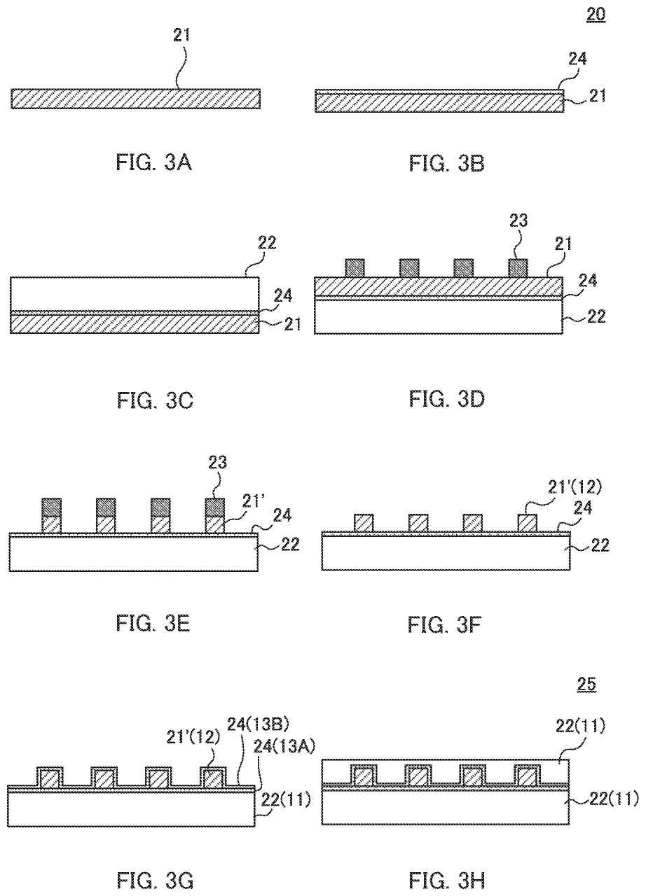

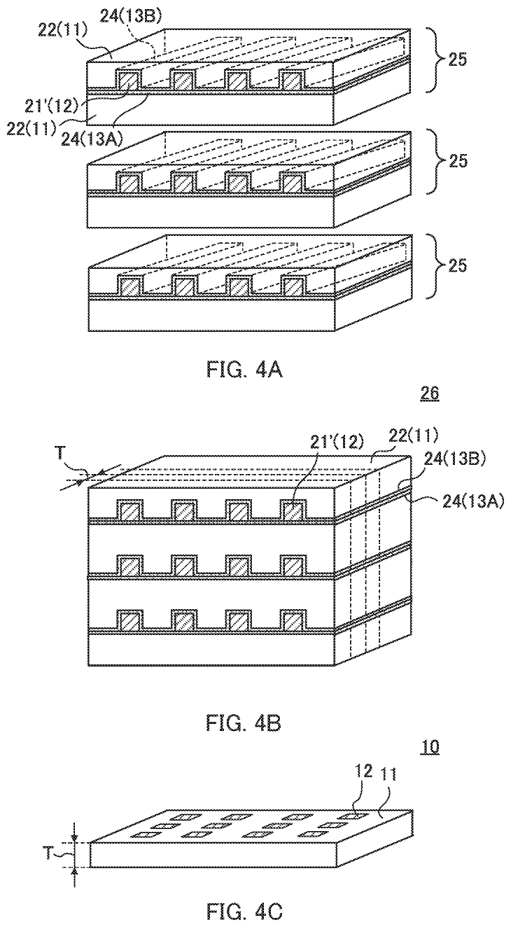

As adhesive layer 13 includes first adhesive layer 13A and second adhesive layer 13B, adhesion between units 25 forming insulation layer 11 can be increased (see FIGS. 3A to 4C described below). In particular, first adhesive layer 13A and second adhesive layer 13B both contain the above-described silane coupling agent composition or the polycondensate thereof, and thus silica bonds are formed between these layers, thereby easily obtaining high adhesion.

First adhesive layer 13A and second adhesive layer 13B may have the same composition or may have different compositions. In addition, first adhesive layer 13A and second adhesive layer 13B may be integrated into one layer. Part of first adhesive layer 13A and second adhesive layer 13B may not be in contact with conductive path 12 (see FIG. 1A).

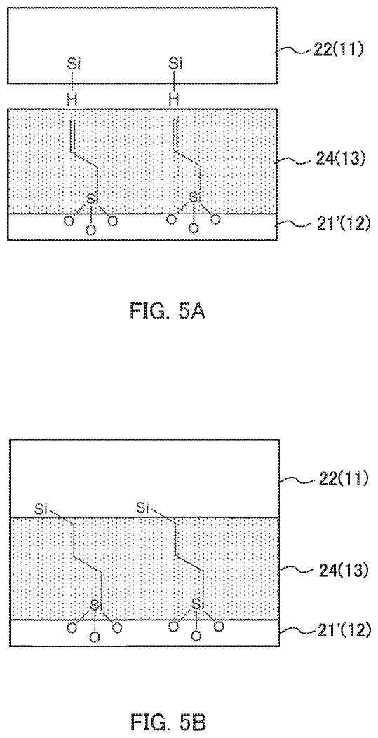

First adhesive layer 13A (or second adhesive layer 13B) includes a silane coupling agent composition that contains a silane coupling agent having vinyl groups and hydrolyzable groups (hereinafter also referred to as “vinyl-based silane coupling agent”) and/or a polycondensate of the silane coupling agent composition. At least part of the vinyl groups of the vinyl-based silane coupling agent in the silane coupling agent composition undergo an addition reaction (hydrosilylation reaction) with the SiH groups of the addition cross-linked product of the silicone rubber composition in insulation layer 11, thereby forming covalent bonds. Further, at least part of the hydrolyzable groups (preferably alkoxysilyl groups) are hydrolyzed to silanol groups, and react (for example, undergo dehydration condensation) with functional groups on conductive path 12 (for example, SiOH groups in the oxide film formed on the surface of conductive path 12), thereby forming bonds (see FIG. 5B described below). Therefore, conductive path 12 and insulation layer 11 are satisfactorily joined to each other via first adhesive layer 13A (or second adhesive layer 13B) containing the silane coupling agent composition and/or a polycondensate thereof.

Silane Coupling Agent Composition

The number of vinyl groups of the vinyl-based silane coupling agent per molecule is not limited, and may be one or two or more, preferably one.

The hydrolyzable group is a reactive group that becomes a hydroxyl group by hydrolysis and chemically bonds with a functional group on conductive path 12, and preferably is an alkoxysilyl group. That is, the vinyl-based silane coupling agent may be an alkoxysilane having a vinyl group. The number of alkoxysilyl groups of the vinyl-based silane coupling agent per molecule is not limited, and may be one or two or more, preferably one.

Examples of the vinyl-based silane coupling agent include vinyltrimethoxysilane (VTMOS), dimethoxymethylvinylsilane (DMMVS), dimethylethoxyvinylsilane, diethoxymethylvinylsilane, vinyltriethoxysilane, triisopropoxyvinylsilane, vinyltri(dimethoxyethoxy)silane, allyltrimethoxysilane (AlyTMOS), and allyltriethoxysilane.

The molecular weight of the vinyl-based silane coupling agent is not limited, but is preferably moderately small from the viewpoint of not impairing the flexibility of first adhesive layer 13A (or second adhesive layer 13B).

The silane coupling agent composition may contain one or more than one type of vinyl-based silane coupling agent.

The content of the vinyl-based silane coupling agent in the silane coupling agent composition is not limited as long as satisfactory adhesion can be obtained between conductive path 12 and insulation layer 11. The content is preferably, for example, 10 to 100 mass % based on the total solid content in the silane coupling agent composition. A vinyl-based silane coupling agent whose content is 10 mass % or more can satisfactorily increase the adhesion between insulation layer 11 and conductive path 12. From the same viewpoint, the content of the vinyl-based silane coupling agent is more preferably 20 to 100 mass % based on the total solid content in the composition.

The silane coupling agent composition may further contain one or more additional components other than the above component, as necessary. Examples of the additional components include other silane coupling agents exclusive of the silane coupling agent described above, and metal alkoxides and hydrolyzed condensates thereof.

The other silane coupling agents do not have a vinyl group. Examples of the other silane coupling agents include silane coupling agents having an amino group (such as aminopropyltrimethoxysilane), silane coupling agents having an epoxy group (such as glycidoxypropyltrimethoxysilane), and silane coupling agents having a mercapto group (such as mercaptopropyltrimethoxysilane).

The metal alkoxide may be a compound represented by the following formula.

(R₁)ₓM(OR₂)₍₄₋ₓ₎

In the formula, R₁ represents a hydrogen atom, an alkyl group (for example, methyl group, ethyl group, or propyl group), an aryl group (for example, phenyl group or tolyl group), a carbon-carbon double bond containing organic group(s) (for example, acryloyl group, methacryloyl group, or vinyl group), and a halogen-containing group (for example, a halogenated alkyl group such as chloropropyl group or fluoromethyl group). R₁'s may be the same or different.

In the formula, R₂ represents a lower alkyl group having 1 to 6 carbon atoms, preferably 1 to 4 carbon atoms. R₂'s may be the same or different.

In the formula, x represents an integer of 2 or less, and y represents an integer of (4-x).

In the formula, M is a metal atom. Examples of the metal atom include silicon, aluminum, zirconium, and titanium atoms, preferably silicon atom.

The metal alkoxide or a hydrolyzed condensate thereof may be a compound that becomes a metal oxide by a sol-gel reaction with the addition of water and a catalyst. Examples of such compounds include alkoxysilanes such as tetramethoxysilane (TMOS), tetraethoxysilane (TEOS), tetrapropoxysilane, tetraisopropoxysilane, tetrabutoxysilane, methyltrimethoxysilane, methyltriethoxysilane, methyltripropoxysilane, methyltributoxysilane, ethyltrimethoxysilane, ethyltriethoxysilane, n-propyltrimethoxysilane, n-propyltriethoxysilane, isopropyltrimethoxysilane, isopropyltriethoxysilane, dimethyldimethoxysilane, dimethyldiethoxysilane, diphenyldimethoxysilane, diphenyldiethoxysilane, phenyltrimethoxysilane, phenyltriethoxysilane, p-styryltrimethoxysilane, 3-chloropropyltriethoxysilane, trifluoromethyltrimethoxysilane, and trifluoromethyltriethoxysilane; and alkoxyaluminum, alkoxyzirconium, and alkoxytitanium corresponding to these alkoxysilanes.

As described above, the silane coupling agent composition may contain not only an alkoxysilane having a vinyl group (at least one of monofunctional to trifunctional alkoxysilanes) as the vinyl-based silane coupling agent, but also an alkoxysilane (at least one of monofunctional to tetrafunctional alkoxysilanes) as another silane coupling agent or a metal alkoxide. In such a case, the amount of a tetrafunctional alkoxysilane is preferably less than the total amount of monofunctional to trifunctional alkoxysilanes in the silane coupling agent composition from the viewpoint of increasing the flexibility of obtained first adhesive layer 13A (or second adhesive layer 13B) to further increase the adhesiveness between conductive path 12 and insulation layer 11.

Specifically, the amount of the tetrafunctional alkoxysilane contained in the silane coupling agent composition is preferably 50 mass % or less, more preferably 30 mass % or less, based on the total amount of the monofunctional to tetrafunctional alkoxysilanes contained in the silane coupling agent composition.

The silane coupling agent composition may further contain a solvent, a curing accelerator, and/or the like as necessary.

The solvent is not limited as long as the above components can disperse or dissolve in the solvent. Examples of the solvent include organic solvents such as xylene, toluene, benzene, heptane, hexane, trichloroethylene, perchloroethylene, methylene chloride, ethyl acetate, methyl isobutyl ketone, methyl ethyl ketone, ethanol, isopropanol, butanol, cyclohexanone, diethyl ether, rubber volatile oil, and silicone solvents. As the curing accelerator, the same addition reaction catalyst (e.g., platinum group metal-based catalyst) as described above can be used.

The silane coupling agent composition or the polycondensate thereof in first adhesive layer 13A (or second adhesive layer 13B) preferably has an elastic modulus higher than that of the addition cross-linked product of the SiH group-containing silicone rubber composition in insulation layer 11, and approximately the same as or lower than that of the metal material in conductive path 12.

Thickness of first adhesive layer 13A (or second adhesive layer 13B) The thickness of first adhesive layer 13A (or second adhesive layer 13B) is not limited as long as satisfactory adhesion can be obtained between insulation layer 11 and conductive path 12. The thickness may be, for example, 1 to 40% of equivalent circle diameter d of conductive path 12 on the first surface 11a side. A thickness of first adhesive layer 13A (or second adhesive layer 13B) of 1% or more with respect to equivalent circle diameter d of conductive path 12 is more likely to achieve satisfactory adhesion between conductive path 12 and insulation layer 11. A thickness of 40% or less is less likely to impair the flexibility of conductive path 12. From the same viewpoint, the thickness of first adhesive layer 13A (or second adhesive layer 13B) is more preferably 2 to 30% of equivalent circle diameter d of conductive path 12. Specifically, the thickness of first adhesive layer 13A (or second adhesive layer 13B) may be 0.05 to 3 μm. The thickness of first adhesive layer 13A (or second adhesive layer 13B) refers to thickness (t) of the adhesive layer in the direction orthogonal to the thickness direction of insulation layer 11 (see FIG. 2).

2. Method for Producing Anisotropic Conductive Sheet

Any method may be used for producing anisotropic conductive sheet 10 according to the present embodiment. For example, anisotropic conductive sheet 10 according to the present embodiment may be produced through the following steps: 1) preparing a plurality of units each including an insulation layer, a plurality of conductive lines disposed on the surface of the insulation layer, and an adhesive layer covering at least part of the peripheries of the plurality of conductive lines; 2) stacking and integrating the plurality of units to obtain a laminate; and 3) cutting the laminate along the stacking direction of the laminate to obtain anisotropic conductive sheets.

In step 1), any conductive line may be used as each conductive line, and a known conductive line may be used as it is, or a conductive layer (for example, metal foil) may be etched to obtain the conductive lines. An example in which the plurality of conductive lines are formed by etching will be described below.

FIGS. 3A to 3H are schematic cross-sectional views illustrating some of the steps of a method for producing anisotropic conductive sheet 10 according to the present embodiment. FIGS. 4A to 4C schematically illustrate the remaining steps of the method for producing anisotropic conductive sheet 10 according to the present embodiment. FIGS. 5A and 5B schematically illustrate the adhesion mechanism by silane coupling agent composition 24. FIG. 5A illustrates the state before an addition reaction, and FIG. 5B illustrates the state after the addition reaction. Note that, adhesive layer 13 is not illustrated in FIG. 4C.

Anisotropic conductive sheet 10 according to the present embodiment may be produced through the following steps: i) preparing insulation layer-metal foil laminate 20 including metal foil 21 and insulation layer 22 (see FIGS. 3A to 3C); ii) etching metal foil 21 of insulation layer-metal foil laminate 20 to obtain plurality of conductive lines 21′ (see FIGS. 3D to 3F); iii) applying silane coupling agent composition 24 onto plurality of conductive lines 21′ (see FIG. 3G); iv) sealing plurality of conductive lines 21′ with a rubber composition to obtain unit 25 (see FIG. 3H); v) stacking plurality of obtained units 25 to obtain laminate 26 (see FIGS. 4A and 4B); and vi) cutting obtained laminate 26 along the stacking direction to obtain anisotropic conductive sheet 10 (see FIG. 4C).

Step i)

Insulation layer-metal foil laminate 20 including metal foil 21 and insulation layer 22 is prepared (see FIGS. 3A to 3C).

Any method may be used for preparing insulation layer-metal foil laminate 20. For example, the above silicone rubber composition is applied or laminated on metal foil 21 directly or via an adhesive layer, and then subjected to addition cross-linking, thereby obtaining insulation layer-metal foil laminate 20. In the present embodiment, after silane coupling agent composition 24 is applied onto metal foil 21 to form first adhesive layer 13A, a silicone rubber composition is further applied to form insulation layer 22. The above procedure obtains an insulation layer-metal foil laminate including metal foil 21, insulation layer 22, and first adhesive layer 13A disposed therebetween (see FIGS. 3B and 3C).

Metal foil 21 is a material of conductive path 12. Metal foil 21 preferably contains at least one metal selected from the group consisting of gold, silver, copper, and alloys thereof, and more preferably is copper foil (for example, rolled copper foil), from the viewpoint of reducing of the indentation load during electrical testing, and because of the satisfactory conductivity and flexibility of these metals and alloys.

Silane coupling agent composition 24 (to become first adhesive layer 13A) may be the silane coupling agent composition described above. Silane coupling agent composition 24 (to become first adhesive layer 13A) and silane coupling agent composition 24 (to become second adhesive layer 13B) described below may have the same composition or different compositions. From the viewpoint of increasing adhesion between first adhesive layer 13A and below described second adhesive layer 13B, the same composition is preferred.

In the present embodiment, insulation layer 22 contains a) an addition cross-linked product of a silicone rubber composition. The addition cross-linked product has a cross-linked structure derived from a hydrosilylation reaction between a vinyl group-containing organopolysiloxane and a SiH group-containing organopolysiloxane, and includes unreacted SiH groups (see FIG. 5A described below). Such insulation layer 22 can be obtained by applying an addition cross-linking silicone rubber composition onto the coating film obtained from silane coupling agent composition 24 and then heating and drying the composition. An addition cross-linking silicone rubber composition is usually liquid at room temperature.

Step ii) Subsequently, metal foil 21 of insulation layer-metal foil laminate 20 is etched to form plurality of conductive lines 21′ (see FIGS. 3D to 3F). Plurality of conductive lines 21′ correspond to each line L in FIG. 1A.

In the present embodiment, mask 23 in a pattern is disposed on metal foil 21 of insulation layer-metal foil laminate 20, and the portion of metal foil 21 not covered with mask 23 is removed by etching (see FIGS. 3D and 3E).

Mask 23 may be, for example, a photoresist pattern formed in a predetermined pattern. With the photoresist pattern as the mask, exposed metal foil 21 is etched to form conductive lines 21′ having a shape and/or size substantially the same as that of the photoresist pattern.

The etching method is not limited, but may be chemical etching, for example. The etching may be performed, for example, by bringing metal foil 21, with mask 23 disposed thereon, into contact with an etchant (for example, spraying the etchant).

As the etchant, a cupric chloride aqueous solution or a ferric chloride aqueous solution may be used. The treatment with an etchant can be performed, for example, under conditions of a temperature of 40 to 50° C., a shower pressure of 0.1 to 0.7 MPa, and a treatment time of 20 to 120 seconds.

After the etching, mask 23 is removed to obtain plurality of conductive lines 21′ (see FIG. 3F). Mask 23 made of a photoresist pattern can be peeled off or removed by using, for example, an alkaline solution. In the present embodiment, plurality of conductive lines 21′ are disposed in such a way that the extending directions thereof in plan view are inclined with respect to the intended cutting line.

Step iii) Subsequently, silane coupling agent composition 24 (to become second adhesive layer 13B) is applied onto plurality of conductive lines 21′ (see FIG. 3G).

Silane coupling agent composition 24 may be applied by any application method such as using a baker applicator or by spraying.

The applied silane coupling agent composition is then dried to obtain second adhesive layer 13B. In this step, it is preferable that at least part of silane coupling agent composition 24 is subjected to polycondensation from the viewpoint of facilitating firm adhesion to insulation layer 11 described below.

Polycondensation may be the following reaction: alkoxysilyl groups of the vinyl-based silane coupling agent (and/or metal alkoxide and the like) in the silane coupling agent composition hydrolyze to become silanol groups, which condense with alkoxysilyl groups or silanol groups in another vinyl-based silane coupling agent or metal alkoxide.

Polycondensation can be carried out, for example, by drying a coating film obtained from the silane coupling agent composition at room temperature and then heating the coating film. Specifically, the coating film obtained from the applied silane coupling agent composition may be dried at room temperature for 5 seconds or longer and then baked at 50° C. or higher for 5 seconds to 30 minutes.

Furthermore, at least part of the hydrolyzable groups of the vinyl-based silane coupling agent contained in silane coupling agent composition 24 may be hydrolyzed to bond with the functional groups on conductive line 21′ (see FIG. 5A described below).

In the present embodiment, by forming first adhesive layer 13A on insulation layer 22, cissing or the like is less likely to occur (as compared to the case where first adhesive layer 13A is not formed). As a result, silane coupling agent composition 24 (to becomes second adhesive layer 13B) can be applied more uniformly, and high adhesion is more likely to be obtained between the resulting layers. In particular, when both first adhesive layer 13A and second adhesive layer 13B are obtained from silane coupling agent composition 24, the condensation reaction between the silanol groups forms silica bonds, resulting in high adhesion.

By forming first adhesive layer 13A, the solvent contained in silane coupling agent composition 24 (to becomes second adhesive layer 13B) is less likely to permeate insulation layer 11 located below (as compared to the case where first adhesive layer 13A is not formed). Swelling of insulation layer 22, which would be caused by the permeation, is thus more likely to be prevented, and deformation of insulation layer 22 is further prevented.

Step iv) Subsequently, a silicone rubber composition is applied in such a way that the plurality of conductive lines 21′ with silane coupling agent composition 24 applied thereon are embedded in the silicone rubber composition (see FIG. 3H).

The silicone rubber composition to be used in step iii) may be substantially the same as the silicone rubber composition used in step i) above. The composition of the rubber composition in step iii) may be the same as or different from that in step i). From the viewpoint of facilitating integration of the units, the silicone rubber composition used in step iii) preferably has the same composition as the silicone rubber composition used in step i) above.

The applied silicone rubber composition is then heated to be subjected to addition cross-linking. The heating forms insulation layer 22 containing the addition cross-linked product of the silicone rubber composition. As a result, unit 25 including insulation layer 22 with plurality of conductive lines 21′ embedded therein is obtained (see FIG. 3H).

By this heating, at least part of the vinyl groups of the vinyl-based silane coupling agent in silane coupling agent composition 24 is subjected to an addition reaction with unreacted SiH groups in silicone rubber composition (in insulation layer 22) to form bonds (see FIGS. 5A and 5B). Thereby, adhesive layer 13 containing silane coupling agent composition 24 and/or the polycondensate thereof is formed, and also conductive line 21′ is satisfactorily joined with insulation layer 22 via adhesive layer 13.

The silicone rubber composition is preferably heated under the condition such that both the following reactions proceed: an addition cross-linking reaction in the silicone rubber composition; and an addition reaction (hydrosilylation reaction) between the vinyl group of the vinyl-based silane coupling agent in the silane coupling agent composition 24 and the SiH group in the silicone rubber composition. From such a point of view, the heating temperature may be preferably 80° C. or more, more preferably 120° C. or more. The heating time depends on the heating temperature, but may be, for example, 1 to 150 minutes.

Step v)

Subsequently, plurality of obtained units 25 are stacked and integrated to obtain laminate 26 (see FIGS. 4A and 4B). In the present embodiment, plurality of units 25 are stacked in such a way that the units face the same direction (see FIG. 4A).

From the viewpoint of increasing the adhesiveness between units 25, the surfaces of units 25 to be stacked may be subjected to surface treatment such as corona treatment, plasma treatment, UV treatment, or Itro treatment in advance.

Any method, such as thermal compression bonding, may be used for integrating plurality of units 25. For example, stacking and integrating are sequentially repeated to obtain laminate 26 having a shape of a block (see FIG. 4B).

Step vi) Obtained laminate 26 is cut at predetermined intervals (T) in a cutting direction which (preferably orthogonally) intersects the axial direction of conductive line 21′ and is along the stacking direction (dotted line in FIG. 4B). As a result, anisotropic conductive sheets 10 having predetermined thickness (T) can be obtained (see FIG. 4C).

In the obtained anisotropic conductive sheet 10, insulation layer 11 is derived from insulation layer 22, and plurality of conductive paths 12 are derived from plurality of conductive lines 21′.

Obtained anisotropic conductive sheet 10 is preferably used for electrical testing.

3. Electrical Testing Apparatus and Electrical Testing Method

Electrical Testing Apparatus

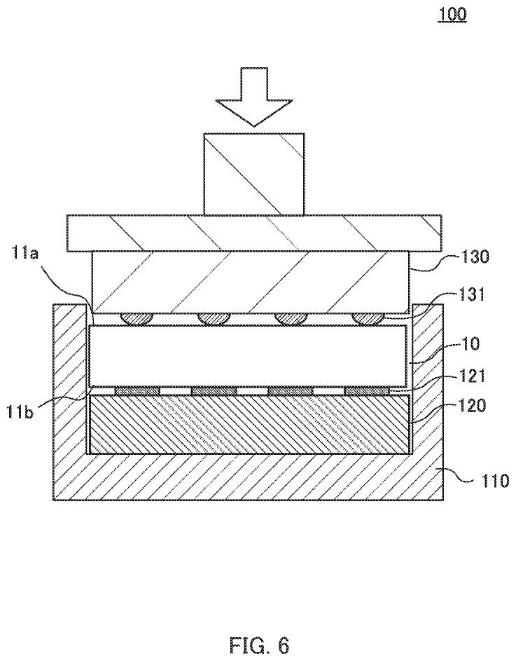

FIG. 6 is a sectional view illustrating exemplary electrical testing apparatus 100 according to the present embodiment.

Electrical testing apparatus 100 includes anisotropic conductive sheet 10 of FIGS. 1A and 1B, and inspects, for example, the electrical characteristics (such as conduction) of inspection object 130 between its terminals 131 (measurement points). FIG. 6 also illustrates inspection object 130 for describing the electrical testing method.

As illustrated in FIG. 6, electrical testing apparatus 100 includes holding container (socket) 110, inspection board 120, and anisotropic conductive sheet 10.

Holding container (socket) 110 is configured to hold inspection board 120, anisotropic conductive sheet 10, and the like.

Inspection board 120 is disposed in holding container 110, and includes, on the surface facing inspection object 130, plurality of electrodes 121 facing corresponding measurement points of inspection object 130.

Anisotropic conductive sheet 10 is disposed above the surface, where electrodes 121 are disposed, of inspection board 120 in such a way that electrodes 121 are in contact with conductive paths 12 of anisotropic conductive sheet 10 on the second surface 11b side.

Inspection object 130 is not limited, but examples thereof include various semiconductor devices (semiconductor packages) such as HBM and PoP, electronic components, and printed boards. When inspection object 130 is a semiconductor package, the measurement point may be a bump (terminal). In addition, when inspection object 130 is a printed board, the measurement point may be a measurement land provided on a conductive pattern, or a component mounting land.

Electrical Testing Method

An electrical testing method using electrical testing apparatus 100 of FIG. 6 is described below.

As illustrated in FIG. 6, the electrical testing method according to the present embodiment includes the following step: stacking inspection object 130 and inspection board 120 including electrodes 121 via anisotropic conductive sheet 10, and electrically connecting electrodes 121 of inspection board 120 with terminals 131 of inspection object 130 via anisotropic conductive sheet 10.

During the above-described step, inspection object 130 may be pressurized or placed in a heated atmosphere for contact as necessary, from the viewpoint of facilitating satisfactory conductivity of electrodes 121 of inspection board 120 with terminals 131 of inspection object 130 via anisotropic conductive sheet 10.

Effect

Anisotropic conductive sheet 10 according to the present embodiment includes adhesive layer 13 (first adhesive layer 13A and second adhesive layer 13B) disposed between each conductive path 12 and insulation layer 11. The presence of such an adhesive layer increases the adhesion between each conductive path 12 and insulation layer 11. Therefore, it is possible to prevent conductive path 12 from peeling off from insulation layer 11 in anisotropic conductive sheet 10 even after the repetition of pressurization and depressurization during electrical testing.

Forming conductive path 12 from a flexible metal material, such as copper, can reduce the indentation load, but such conductive path 12 is more likely to be peeled off by the repeated pressurization and depressurization. In anisotropic conductive sheet 10 of the present invention, conductive path 12 is less likely to be peeled off from insulation layer 11 even in such a case. Therefore, accurate electrical testing can be performed.

Variations

The above embodiment describes exemplary anisotropic conductive sheet 10 in which adhesive layer 13 is disposed so as to entirely cover side surface 12c of conductive path 12. However, the present invention is not limited thereto, and adhesive layer 13 may be disposed to cover only a portion of side surface 12c. For example, the above embodiment describes an example such that adhesive layer 13 includes first adhesive layer 13A and second adhesive layer 13B. However, the present invention is not limited thereto, and adhesive layer 13 may include only one of first adhesive layer 13A and second adhesive layer 13B (for example, only second adhesive layer 13B).

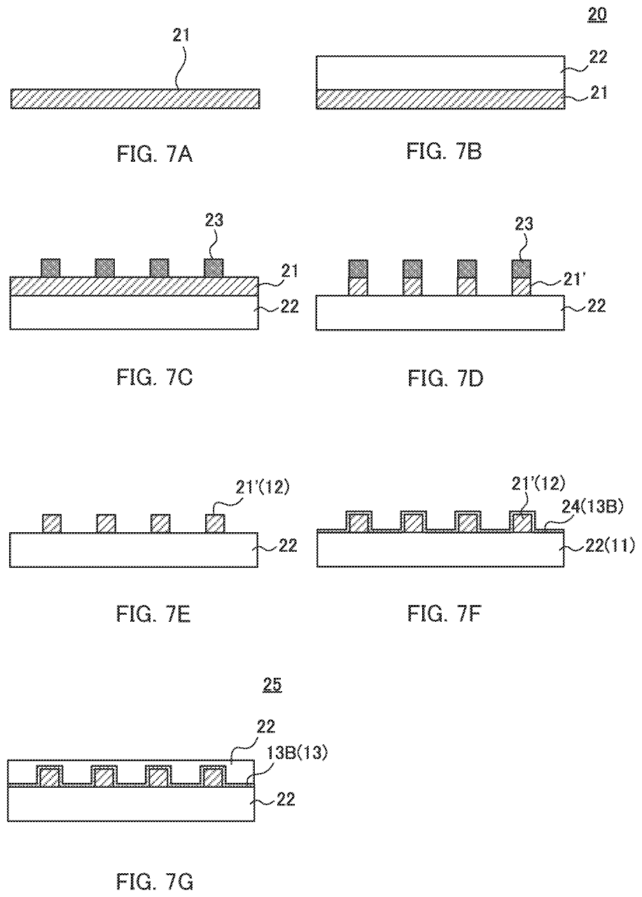

FIGS. 7A to 7G are schematic cross-sectional views illustrating some of the steps of a method for producing anisotropic conductive sheet 10 according to a variation. As illustrated in FIGS. 7A to 7G, anisotropic conductive sheet 10 of the variation can be produced in the same manner as the method for producing anisotropic conductive sheet 10 in the above described embodiment except that, for example, applying of silane coupling agent composition 24 on metal foil 21 (see FIG. 3B) in step i) is not performed (see FIGS. 7A to 7G).

In addition, in step iv) of the method for producing anisotropic conductive sheet 10 in the above embodiment, the addition reaction of the vinyl-based silane coupling agent of the silane coupling agent composition 24 (in adhesive layer 13) proceeds simultaneously with the addition cross-linking reaction of the silicone rubber composition (in insulation layer 22), as an example. However, the present invention is not limited thereto, and those reactions may be performed sequentially. For example, in step iv), the addition reaction of the silane coupling agent may be carried out after the silicone rubber composition is subjected to the addition cross-linking reaction.

In the above embodiment, plurality of units 25 are stacked in such a way that two adjacent units 25 face the same direction (the front surface of one of adjacent units 25 and the back surface of the other one of adjacent units 25 are bonded together), as an example. However, the present invention is not limited thereto, and plurality of units 25 may be stacked in such a way that two adjacent units 25 face each other (for example, the front surface of one of adjacent units 25 and the front surface of the other one of adjacent units 25 are bonded together). In this case, the orientations of the extending directions of conductive lines 21′ may be adjusted as appropriate. For example, when one unit 25 and another unit 25 are stacked so as to face each other, two types of units 25 such that the extending direction of conductive line 21′ of the one unit 25 coincides with the extending direction of conductive line 21′ of the other unit 25 may be used.

The above embodiment describes exemplary anisotropic conductive sheet 10 in which end 12a (or 12b) of conductive path 12 does not protrude from first surface 11a (or second surface 11b). However, the present invention is not limited thereto, and end 12a (or 12b) may protrude from first surface 11a (or second surface 11b). The protrusion height of conductive path 12 on the first surface 11a side (or the protrusion height of conductive path 12 on the second surface 11b side) is not limited. For example, the height may be about 5 to 20% of thickness (T) of insulation layer 11.

In the method for producing anisotropic conductive sheet 10 in the above embodiment, plurality of conductive lines 21′ are formed by etching metal foil 21 of insulation layer-metal foil laminate 20, as an example. However, the present invention is not limited thereto, and plurality of conductive lines 21′ may be formed by disposing known conductive lines (metal wires) on an insulation sheet.

The above embodiment describes exemplary anisotropic conductive sheet 10 in which conductive path 12 is inclined with respect to the thickness direction of insulation layer 11. However, the present invention is not limited thereto, and the conductive path may be substantially parallel to the thickness direction of insulation layer 11.

The above embodiment describes the silicone rubber composition in insulation layer 11 as the above-described addition cross-linking type a), as an example. However, the present invention is not limited thereto, and the silicone rubber composition may be the above-described organic peroxide cross-linking (radical addition) type b). At least part of the vinyl groups of adhesive layer 13 in this case may be bonded to (methyl groups of) SiCH₃ groups of insulation layer 11 by a radical addition reaction.

That is, insulation layer 11 may contain a cross-linked product of a silicone rubber composition that contains an organopolysiloxane having SiCH₃ groups (herein also referred to as “SiCH₃ group-containing organopolysiloxane”) and an organic peroxide curing agent.

Examples of the SiCH₃ group-containing organopolysiloxane include dimethylpolysiloxane and methylphenylpolysiloxane. In these compounds, those in which at least part of the methyl groups is substituted with other alkyl groups or the like are also included as the examples.

Examples of the organic peroxide curing agent include benzoyl peroxide, 2,4-dichlorobenzoyl peroxide, p-methylbenzoyl peroxide, o-methylbenzoyl peroxide, 2,4-dicumyl peroxide, 2,5-dimethyl-2,5-bis(t-butylperoxy)hexane, di-t-butylperoxide, t-butylperbenzoate, and 1,6-hexanediol-bis-t-butylperoxycarbonate.

Such silicone rubber compositions may be of the millable type. The millable type silicone rubber composition is non-liquid (solid or highly viscous paste) without self-fluidity at room temperature. Examples of such silicone rubber compositions include clay-like silicone rubber (for example, KE-174-U, manufactured by Shin-Etsu Chemical Co., Ltd.).

Such an anisotropic conductive sheet can be obtained by a method in the same manner as that of the above embodiment except the following: in step i) above, insulation layer 22 is obtained by a radical addition reaction (thermal curing) of the silicone rubber composition; and step iv) above is performed under the condition such that both the following reactions proceed: radical addition reaction of the silicone rubber composition (to become insulation layer 22); and a radical addition reaction between the vinyl group of the vinyl-based silane coupling agent in silane coupling agent composition 24 (to become adhesive layer 13) and the SiCH₃ group in the silicone rubber composition (to become the insulating layer 22).

The above embodiment describes an exemplary anisotropic conductive sheet (first anisotropic conductive sheet) in which insulation layer 11 contains a silicone elastomer having SiH groups, and adhesive layer 13 contains a silane coupling agent composition containing a silane coupling agent having vinyl groups. However, the present invention is not limited thereto. For example, the following configuration is also possible: an anisotropic conductive sheet (second anisotropic conductive sheet) in which insulation layer 11 contains a silicone elastomer having vinyl groups, and adhesive layer 13 contains a silane coupling agent composition containing a silane coupling agent having SiH groups.

In this case, the silicone rubber composition in insulation layer 11 may be the same as in the above embodiment, except that the resulting addition cross-linked product is adjusted to have a certain amount or more of vinyl groups.

In addition, the silane coupling agent composition in adhesive layer 13 may be the same as in the above embodiment, except that the silane coupling agent composition contains a silane coupling agent having SiH groups in place of the silane coupling agent having vinyl groups. The silane coupling agent having SiH groups is preferably a compound having SiH groups and hydrolyzable groups, and examples thereof includes compounds each having one of the following structures.

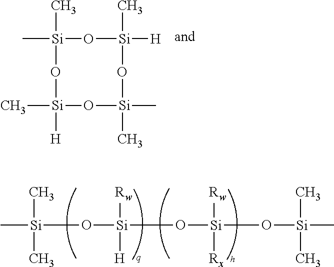

In the above formula, Rw and Rx each represents a substituted or unsubstituted hydrocarbon group. The hydrocarbon group preferably has 1 to 12 carbon atoms, preferably 1 to 8 carbon atoms. Examples of the hydrocarbon group include alkyl groups, aryl groups, aralkyl groups, and alkenyl groups. Examples of the substituents include alkoxy groups, acryl groups, methacryl groups, acryloyl groups, methacryloyl groups, amino groups, and alkylamino groups. In the above formula, q is an integer of 1 to 50, preferably 1 to 20, and h is an integer of 0 to 50, preferably 1 to 10. Examples of such compounds include compounds described in Japanese Patent Application Laid-Open No. 2010-248434 and Japanese Patent Application Laid-Open No. H10-121023.

Such an anisotropic conductive sheet can be produced in the same manner as in the above described embodiment except that, insulation layer 11 includes an addition cross-linked product of a silicone rubber composition including vinyl groups, and adhesive layer 13 includes a silane coupling agent composition containing a silane coupling agent having SiH groups.

The above embodiment describes exemplary anisotropic conductive sheet 10 which is used for electrical testing. However, the present invention is not limited thereto. Anisotropic conductive sheet 10 may also be used for electrical connection between two electronic members, such as electrical connection between a glass substrate and a flexible printed circuit board, or for electrical connection between a substrate and an electronic component mounted on or above the substrate.

### EXAMPLES

Hereinafter, the present invention is described with reference to Examples. The Examples should not be construed as limiting the scope of the present invention.

1. Material of Sample

(1) Material of Insulation Layer

Preparation of Silicone Rubber Composition

Liquids A and B of KE-2061-40-silicone rubber composition containing dimethylpolysiloxane having SiH groups, methylhydrogen dimethylpolysiloxane, and an addition reaction catalyst-(liquid silicone rubber, manufactured by Shin-Etsu Chemical Co., Ltd.) were mixed at a weight ratio of 1:1. The mixture was diluted with toluene to have a concentration of 80%, thereby obtaining an addition-crosslinking silicone rubber composition.

(2) Material of Conductive Path
F1-WS (electrolytic copper foil having a thickness of 12 μm, surface area ratio in rough surface of 1.36, and surface area ratio in glossy surface of 1.03, manufactured by Furukawa Electric Co., Ltd.)
NC-WS (electrolytic copper foil having a thickness of 18 μm, surface area ratio in rough surface of 1.02, and surface area ratio in glossy surface of 1.01, manufactured by Furukawa Electric Co., Ltd.)
GHY5-HA-V2 (rolled copper foil having a thickness of 9 μm, surface area ratio in rough surface of 1.08, and surface area ratio in glossy surface of 0.50, manufactured by JX Nippon Mining & Metals Corporation)

Surface Area Ratio

The surface of the each prepared metal foil was observed with a laser microscope (OLS5000, manufactured by Olympus Corporation, under the condition of a measurement region of 250 μm long by 250 μm wide) to measure the surface area in the measurement region. As the area of the measurement region, the value measured by the laser microscope was used. The obtained values were applied to following Equation (1) to calculate the surface area ratio.

Surface area ratio=surface area/area Equation (1)

The surface area and area of the region were measured three times (n=3), and the surface area ratios were calculated for respective measurements. The average value of the surface area ratios was used as the “surface area ratio.”

(3) Material of Adhesive Layer

Silane coupling agent compositions 1 to 12 shown in Table 1 below were prepared.

TABLE 1

| | Amounts of compositions | | |
|---|---|---|---|
| | | | Concentration |
| Composition | | | (mass %) of Silane |
| No. | Silane coupling agent * | Solvent * | coupling agent |
| 1 | DMMVS/AlyTMOS = 0/10 | IPA/water = 7/3 | 5 |
| 2 | DMMVS/AlyTMOS = 8/2 | IPA/water = 7/3 | 5 |
| 3 | DMMVS/AlyTMOS = 6/4 | IPA/water = 7/3 | 5 |
| 4 | AlyTMOS | IPA/water = 7/3 | 5 |
| 5 | VTMOS | IPA/water = 7/3 | 5 |
| 6 | VTMOS/tetrabutyl titanate/ | n-Heptane | 20 |
| 7 | 3-aminopropyltriethoxysilane = | | 10 |
| 8 | 10-20/3-10/3-10 | | 5 |
| 9 | AlyTMOS | IPA/water = 7/3 | 10 |
| 10 | MerTMOS | IPA/water = 7/3 | 5 |
| 11 | GPTMOS | IPA/water = 7/3 | 5 |
| 12 | MTMOS | IPA/water = 7/3 | 5 |

* “/” represents the mass ratio when multiple types are included
AlyTMOS: Allyltrimethoxysilane
DMMVS: Dimethoxymethylvinylsilane
MerTMOS: (3-Mercaptopropyl)trimethoxysilane
MTMOS: Trimethoxy(methyl)silane
GPTMOS: 3-Glycidyloxypropyltrimethoxysilane
VTMOS: Vinyltrimethoxysilane

2. Preparation and Evaluation of Samples

Preparation of Samples 1 to 9

On each copper foil shown in Table 2, the silane coupling agent composition of Table 2 was applied with a baker applicator, the silane coupling agent was then heated in an inert oven and dried under the conditions shown in Table 2 to form an adhesive layer having a thickness as shown in Table 2. The silicone rubber composition prepared above was applied on the obtained adhesive layer with a baker applicator, and heated in an inert oven at 100° C. for 10 minutes and further heated at 150° C. for 120 minutes to dry and cure the silicone rubber composition. An insulation layer having a thickness of 20 μm and containing an addition cross-linked product of the silicone rubber composition (silicone elastomer having SiH groups) was formed. As a result, each sample having a laminated structure of copper foil/adhesive layer/insulation layer was obtained.

Evaluation

The adhesion between the insulation layer and the copper foil in each obtained sample was evaluated by the following method.

Adhesion

Adhesion was evaluated according to the cross-cut tape peeling test (JIS K 5600-5-6: 1999 (ISO 2409: 1992)) except that the number of squares was 100 and the evaluation was performed according to the criteria described below.

On the surface of the copper foil of each sample, cuts were introduced at 2 mm intervals with a cutter knife to form a grid pattern of 100 squares (10×10). Each cut was made from the surface of the copper foil to the insulation layer (i.e., the layer containing the addition cross-linked product of the silicone rubber composition). An adhesive tape (Cellulose Tape (registered trademark), manufactured by Nichiban Co., Ltd.) was sticked to the portion of the grid pattern with an indentation load of 0.1 MPa. The tape was then rapidly peeled off, the state of peeling at the outermost layer (on the copper foil side) was observed, and the adhesion was evaluated according to the following evaluation criteria.
Excellent: Peeling occurred in less than 10 squares out of 100 squares
Fair: Peeling occurred in 10 or more and less than 50 squares out of 100 squares
Poor: Peeling occurred in 50 or more squares out of 100 squares
Fair or better was determined to be satisfactory.

Table 2 shows the evaluation results of samples 1 to 9.

TABLE 2

| | | Silane coupling agent composition | | | | | | | | |
|---|---|---|---|---|---|---|---|---|---|---|
| | | | | | Concentration | | | | | |
| | | | Silane | | (mass %) | Film formation | | Adhesive | | |
| | Copper | | coupling | | of Silane | condition | | layer | Adhesion | |
| Sample | foil | | agent | Solvent | coupling | Bar coater | Drying | thickness | Tape | |
| No. | Type | No. | (mass ratio) | (mass ratio) | agent | No. | conditions | (μm) | peeling | Remarks |
| 1 | F1-WS | 1 | DMMVS/ | IPA/water = | 5 | #5 | 125° C./5 min | 0.3 | Excellent | Present |
| | (Glossy | | AlyTMOS = | 7/3 | | | | | | invention |
| | surface) | | 0/10 | | | | | | | |
| 2 | | 2 | DMMVS/ | IPA/water = | 5 | #5 | 125° C./5 min | 0.4 | Excellent | Present |
| | | | AlyTMOS = | 7/3 | | | | | | invention |
| | | | 8/2 | | | | | | | |
| 3 | | 3 | DMMVS/ | IPA/water = | 5 | #5 | 125° C./5 min | 0.4 | Excellent | Present |
| | | | AlyTMOS = | 7/3 | | | | | | invention |
| | | | 6/4 | | | | | | | |
| 4 | NC-WS | 4 | AlyTMOS | IPA/water = | 5 | #5 | 125° C./5 min | 0.4 | Excellent | Present |
| | (Glossy | | | 7/3 | | | | | | invention |
| | surface) | | | | | | | | | |
| 5 | GHY5- | 5 | VTMOS | IPA/water = | 5 | #5 | 50° C./5 min | 0.4 | Excellent | Present |
| | HA-V2 | | | 7/3 | | | | | | invention |
| | (Glossy | | | | | | | | | |
| | surface | | | | | | | | | |
| 6 | F1-WS | — | | | | — | | — | Poor | Comp. Ex. |
| 7 | (Glossy | 10 | MerTMOS | IPA/water = | 5 | #5 | 125° C./5 min | 0.4 | Poor | Comp. Ex. |
| | surface) | | | 7/3 | | | | | | |
| 8 | | 11 | GPTMOS | IPA/water = | 5 | #6 | 125° C./5 min | 0.3 | Poor | Comp. Ex. |
| | | | | 7/3 | | | | | | |
| 9 | | 12 | MTMOS | IPA/water = | 5 | #5 | 125° C./5 min | 0.4 | Poor | Comp. Ex. |
| | | | | 7/3 | | | | | | |

Table 2 shows that samples 1 to 5 each obtained from a silane coupling agent composition containing a silane coupling agent having vinyl groups exhibit satisfactory adhesion in the tape peeling test.

On the other hand, sample 6, in which an adhesive layer was not formed, could not obtain satisfactory adhesion in the tape peeling test or in the alkali immersion ultrasonic test. In addition, samples 7 to 9 each obtained from a silane coupling agent composition containing a silane coupling agent without vinyl group (MerTMOS, MTMOS, GPTMOS) could not obtain satisfactory adhesion in the tape peeling test, either.

Preparation of Samples 10 to 17

Each sample having a laminated structure of copper foil/adhesive layer/insulation layer was obtained in the same manner as sample 1, except that the type of silane coupling agent composition and film formation conditions were changed as shown in Table 3.

Evaluation

The adhesion between the insulation layer and the copper foil in each obtained sample was evaluated by the method as described above. Table 3 shows the results.

TABLE 3

| | | Silane coupling agent composition | | | | | | | | |
|---|---|---|---|---|---|---|---|---|---|---|
| | | | | | Concentration | | | | | |
| | | | | | (mass %) | Film formation | | Adhesive | | |
| | Copper | | Silane | | of Silane | condition | | layer | Adhesion | |
| Sample | foil | | coupling | Solvent | coupling | Bar coater | Drying | thickness | Tape | |
| No. | Type | No. | agent | (mass ratio) | agent | No. | conditions | (μm) | peeling | Remarks |
| 10 | F1-WS | 6 | VTMOS/ | n-Heptane | 20 | #5 | Air dry/40 min | 1.5 | Excellent | Present |
| | (Glossy | | tetrabutyl | | | | | | | invention |
| 11 | surface) | 7 | titanate/ | | 10 | #5 | Air dry/40 min | 0.8 | Excellent | Present |
| | | | 3-aminopropyl- | | | | | | | invention |
| 12 | | 8 | triethoxysilane = | | 5 | #5 | Air dry/40 min | 0.4 | Excellent | Present |
| | | | 10-20/3-10/3-10 | | | | | | | invention |
| 13 | | 6 | | | 20 | #5 | 50° C./5 min | 1.2 | Excellent | Present |
| | | | | | | | | | | invention |
| 14 | | 6 | | | 20 | #5 | 50° C./10 min | 1.1 | Excellent | Present |
| | | | | | | | | | | invention |
| 15 | | 9 | AlyTMOS | IPA/water = | 10 | #5 | 125° C./5 min | 0.6 | Excellent | Present |
| | | | | 7/3 | | | | | | invention |
| 16 | | | | | | #10 | | 1.1 | Excellent | Present |
| | | | | | | | | | | invention |
| 17 | | | | | | #15 | | 1.3 | Excellent | Present |
| | | | | | | | | | | invention |

Table 3 shows that samples 10 to 17 each obtained from a silane coupling agent composition containing a silane coupling agent having vinyl groups exhibit satisfactory adhesion in the tape peeling test.

This application is entitled to and claims the benefit of Japanese Patent Application No. 2020-119278 filed on Jul. 10, 2020, the disclosure of which including the specification and drawings is incorporated herein by reference in its entirety.

### INDUSTRIAL APPLICABILITY

The present invention is capable of providing an anisotropic conductive sheet that can maintain satisfactory adhesion and suffers little peeling of a conductive path even after repeated elastic deformation.

### REFERENCE SIGNS LIST

10 Anisotropic conductive sheet
11 Insulation layer
11a First surface
11b Second surface
12 Conductive path
12a, 12b End
12c Side surface
13 Adhesive layer
13A First adhesive layer
13B Second adhesive layer
20 Insulation layer-metal foil laminate
21 Metal foil
21′ Conductive line
22 Insulation layer
23 Mask
24 Silane coupling agent composition
25 Unit
26 Laminate
100 Electrical testing apparatus
110 Holding container
120 Inspection board
121 Electrode
130 Inspection object
131 Terminal (of inspection object)

What is claim is:

1. An anisotropic conductive sheet, comprising:
an insulation layer including a first surface located on one side in a thickness direction of the insulation layer, and a second surface located on another side in the thickness direction;
a plurality of conductive paths disposed in the insulation layer so as to each extend in the thickness direction, each of the plurality of conductive paths being exposed to an outside of the first surface and an outside of the second surface; and
a plurality of adhesive layers, at least part of each of the plurality of adhesive layers being disposed between a corresponding one of the plurality of conductive paths and the insulation layer,
wherein
each of the plurality of adhesive layers includes a silane coupling agent composition and/or a polycondensate thereof, the silane coupling agent composition containing a silane coupling agent having at least one vinyl group and at least one hydrolyzable group, and
the anisotropic conductive sheet satisfies any one of a) and b) below:
a) the insulation layer contains an addition cross-linked product of a silicone rubber composition, the silicone rubber composition containing an organopolysiloxane having at least one SiH group, an organopolysiloxane having at least one vinyl group, and an addition reaction catalyst, and
at least part of the at least one vinyl group in each of the plurality of adhesive layers is bonded to at least part of the at least one SiH group in the insulation layer by an addition reaction, and
b) the insulation layer contains a cross-linked product of a silicone rubber composition, the silicone rubber composition containing an organopolysiloxane having at least one SiCH₃ group, and an organic peroxide curing agent, and
at least part of the at least one vinyl group in each of the plurality of adhesive layers is bonded to at least part of the at least one SiCH₃ group in the insulation layer by a radical addition reaction.

2. The anisotropic conductive sheet according to claim 1, wherein:
the insulation layer contains the addition cross-linked product of the silicone rubber composition containing the organopolysiloxane having the at least one SiH group, the organopolysiloxane having the vinyl group, and the addition reaction catalyst; and
the at least part of the at least one vinyl group in each of the plurality of adhesive layers is bonded to the at least part of the at least one SiH group in the insulation layer by the addition reaction.

3. The anisotropic conductive sheet according to claim 1, wherein
at least part of the at least one hydrolyzable group is bonded to a functional group on each of the plurality of conductive paths.

4. The anisotropic conductive sheet according to claim 1, wherein
the at least one hydrolyzable group includes an alkoxysilyl group.

5. The anisotropic conductive sheet according to claim 4, wherein:
the silane coupling agent composition contains one or more alkoxysilanes including the silane coupling agent; and
a content of a tetrafunctional alkoxysilane among the one or more alkoxysilanes contained in the silane coupling agent composition is 30 mass % or less based on a total amount of monofunctional to tetrafunctional alkoxysilanes among the one or more alkoxysilanes contained in the silane coupling agent composition.

6. The anisotropic conductive sheet according to claim 1, wherein:
the plurality of conductive paths include a line including the plurality of conductive paths arranged in a row;
the plurality of adhesive layers include
a plurality of first adhesive layers disposed along the line of the plurality of conductive paths in such a way that the plurality of first adhesive layers are in contact with respective side surfaces of the plurality of conductive paths in the line, the side surfaces being on one side of the line, and
a plurality of second adhesive layers disposed on or above the plurality of first adhesive layers and along the line of the plurality of conductive paths in such a way that the plurality of second adhesive layers are in contact with respective side surfaces of the plurality of conductive paths in the line, the side surfaces being on another side of the line; and
the plurality of first adhesive layers and/or the plurality of second adhesive layers contain the silane coupling agent composition and/or the polycondensate thereof.

7. The anisotropic conductive sheet according to claim 6, wherein
the plurality of first adhesive layers are planar.

8. The anisotropic conductive sheet according to claim 6, wherein
a thickness of each of the plurality of first adhesive layers and the plurality of second adhesive layers is 1 to 40% of an equivalent circle diameter of an end of each of the plurality of conductive paths, the end being on a side of the first surface.

9. The anisotropic conductive sheet according to claim 6, wherein
a thickness of each of the plurality of first adhesive layers and the plurality of second adhesive layers is 0.05 to 3 μm.

10. The anisotropic conductive sheet according to claim 1, wherein
each of the plurality of conductive paths contains at least one member selected from the group consisting of gold, silver, copper, and alloys thereof.

11. The anisotropic conductive sheet according to claim 10, wherein
each of the plurality of conductive paths contains copper or an alloy thereof.

12. The anisotropic conductive sheet according to claim 11, wherein
each of the plurality of conductive paths is derived from copper foil.

13. The anisotropic conductive sheet according to claim 1, wherein
an extending direction of each of the plurality of conductive paths is inclined with respect to the thickness direction of the insulation layer.

14. The anisotropic conductive sheet according to claim 1, wherein
on a side of the first surface, a center-to-center distance of the plurality of conductive paths is 5 to 55 μm.

15. The anisotropic conductive sheet according to claim 1, wherein:
the anisotropic conductive sheet is used for electrical testing of an inspection object; and
the inspection object is disposed on or above the first surface.

16. A method for producing an anisotropic conductive sheet, the method comprising:
1) preparing a plurality of units each including an insulation layer, a plurality of conductive lines disposed on or above a surface of the insulation layer, and an adhesive layer covering at least part of peripheries of the plurality of conductive lines, the adhesive layer containing a silane coupling agent composition and/or a polycondensate thereof;
2) stacking and integrating the plurality of units to obtain a laminate; and
3) cutting the laminate in a cutting direction along a stacking direction of the laminate to obtain an anisotropic conductive sheet, the cutting direction intersecting an extending direction of at least one of the plurality of conductive lines,
wherein
the silane coupling agent composition contains a silane coupling agent having at least one vinyl group and at least one hydrolyzable group, and
the method satisfies any one of a) and b) below:
a) the insulation layer contains an addition cross-linked product of a silicone rubber composition, the silicone rubber composition containing an organopolysiloxane having at least one SiH group, an organopolysiloxane having at least one vinyl group, and an addition reaction catalyst, and
in the preparing, at least part of the at least one vinyl group in the adhesive layer is subjected to an addition reaction with at least part of the at least one SiH group in the insulation layer,
b) the insulation layer contains a cross-linked product of a silicone rubber composition, the silicone rubber composition containing an organopolysiloxane having at least one SiCH₃ group, and an organic peroxide curing agent, and
in the preparing, at least part of the at least one vinyl group in the adhesive layer is subjected to a radical addition reaction with the at least part of the at least one SiCH₃ group in the insulation layer.

17. The method according to claim 16, wherein:
the insulation layer contains the addition cross-linked product of the silicone rubber composition containing the organopolysiloxane having the at least one SiH group, the organopolysiloxane having the at least one vinyl group, and the addition reaction catalyst, and
in the preparing, the at least part of the at least one vinyl group in the adhesive layer is subjected to the addition reaction with the at least part of the at least one SiH group in the insulation layer.

18. The method according to claim 16, wherein
in the preparing,
at least part of the at least one hydrolyzable group is bonded to a functional group on each of the plurality of conductive lines.

19. The method according to claim 16, wherein
the at least one hydrolyzable group includes an alkoxysilyl group.

20. The method according to claim 16, wherein:
the silane coupling agent composition contains one or more alkoxysilanes including the silane coupling agent; and
a content of a tetrafunctional alkoxysilane among the one or more alkoxysilanes contained in the silane coupling agent composition is 30 mass % or less based on a total amount of monofunctional to tetrafunctional alkoxysilanes among the one or more alkoxysilanes contained in the silane coupling agent composition.

21. The method according to claim 16, wherein
in the preparing,
the plurality of conductive lines are formed by etching metal foil disposed on or above the insulation layer, the metal foil containing at least one member selected from the group consisting of gold, silver, copper, and alloys thereof.

22. The method according to claim 21, wherein
the metal foil is copper foil.

23. The method according to claim 21, wherein:
a first adhesive layer is disposed between the insulation layer and the plurality of conductive lines;
the method further comprises forming a second adhesive layer to cover the peripheries of the plurality of conductive lines; and
at least one of the first adhesive layer and/or the second adhesive layer contains a silane coupling agent composition and/or a polycondensate thereof.

24. The method according to claim 16, wherein
the integrating is performed by heat pressing.

25. An anisotropic conductive sheet, comprising:
an insulation layer including a first surface located on one side in a thickness direction of the insulation layer, and a second surface located on another side in the thickness direction;
a plurality of conductive paths disposed in the insulation layer so as to each extend in the thickness direction, each of the plurality of conductive paths being exposed to an outside of the first surface and an outside of the second surface; and
a plurality of adhesive layers, at least part of each of the plurality of adhesive layers being disposed between a corresponding one of the plurality of conductive paths and the insulation layer,
wherein
the insulation layer contains an addition cross-linked product of a silicone rubber composition having at least one vinyl group,
each of the plurality of adhesive layers includes a silane coupling agent composition and/or a polycondensate thereof, the silane coupling agent composition containing a silane coupling agent having at least one SiH group and at least one hydrolyzable group, and
at least part of the at least one SiH group in each of the plurality of adhesive layers is bonded to at least part of the at least one vinyl group in the insulation layer by the addition reaction.

26. A method for producing an anisotropic conductive sheet, the method comprising:
1) preparing a plurality of units each including an insulation layer containing an addition cross-linked product of a silicone rubber composition having at least one vinyl group, a plurality of conductive lines disposed on or above a surface of the insulation layer, and an adhesive layer covering at least part of peripheries of the plurality of conductive lines, the adhesive layer containing a silane coupling agent composition and/or a polycondensate thereof;
2) stacking and integrating the plurality of units to obtain a laminate; and
3) cutting the laminate in a cutting direction along a stacking direction of the laminate to obtain an anisotropic conductive sheet, the cutting direction intersecting an extending direction of at least one of the plurality of conductive lines,
wherein
in the preparing,
the silane coupling agent composition contains a silane coupling agent having at least one SiH group and at least one hydrolyzable group, and
at least part of the at least one SiH group is subjected to the addition reaction with at least part of the at least one vinyl group in the insulation layer.

27. An electrical testing apparatus, comprising:
an inspection board including a plurality of electrodes; and
the anisotropic conductive sheet according to claim 1 disposed on or above a surface of the inspection board, the surface being a surface on which the plurality of electrodes are disposed.

28. An electrical testing method, comprising:
stacking, via the anisotropic conductive sheet according to claim 1, an inspection board including a plurality of electrodes, and an inspection object including a terminal, and electrically connecting the plurality of electrodes of the inspection board with the terminal of the inspection object via the anisotropic conductive sheet.
